(19) United States
(12) Patent Application Publication
(10) Pub. No.: US 2025/0182294 A1
(43) Pub. Date: Jun. 5, 2025

(54) EXPANDING TOKEN LENGTHS IN TRANSFORMER ENCODERS

(71) Applicant: NEC Laboratories America, Inc., Princeton, NJ (US)

(72) Inventors: Abhishek Aich, San Jose, CA (US); Yumin Suh, Santa Clara, CA (US); Samuel Schulter, Long Island City, NY (US)

(21) Appl. No.: 18/968,277

(22) Filed: Dec. 4, 2024

Related U.S. Application Data
(60) Provisional application No. 63/606,219, filed on Dec. 5, 2023.
(60) Provisional application No. 63/624,843, filed on Jan. 25, 2024.
(60) Provisional application No. 63/643,480, filed on May 7, 2024.

(51) Int. Cl. G06T 7/149

(52) U.S. Cl. CPC G06T 7/149; G06T 2207/20016; G06T 2207/20084

(57) ABSTRACT

Methods and systems for image segmentation include generating features at multiple scales from an input image using a backbone model. The features are encoded using a transformer encoder that creates a per-pixel embedding map from a high-resolution scale of the multiple scales using deformable attention layers that operate on progressively higher-resolution scales of the multiple scales. The features are decoded using a transformer decoder to generate a segmentation mask.

### RELATED APPLICATION INFORMATION

This application claims priority to U.S. Patent Application No. 63/606,219, filed on Dec. 5, 2023, U.S. Patent Application No. 63/624,843, filed on Jan. 25, 2024, and U.S. Patent Application No. 63/643,480, filed on May 7, 2024, each incorporated herein by reference in its entirety.

### BACKGROUND

### Technical Field

The present invention relates to machine learning models and, more particularly, to scene segmentation.

### Description of the Related Art

Image segmentation can be handled using transformer neural network models that represent categories using general tokens. This makes it possible to handle the various image segmentation tasks, including instance, semantic, and panoptic segmentation, using a single model. In particular, detection transformers (DETRs) perform well across various segmentation tasks without the need for task-specific design choices. However, this performance comes at the cost of significant computational overhead, which limits the model's scalability.

### SUMMARY

A method for image segmentation includes generating features at multiple scales from an input image using a backbone model. The features are encoded using a transformer encoder that creates a per-pixel embedding map from a high-resolution scale of the multiple scales using deformable attention layers that operate on progressively higher-resolution scales of the multiple scales. The features are decoded using a transformer decoder to generate a segmentation mask.

A system for image segmentation includes a hardware processor and a memory that stores a computer program. When executed by the hardware processor, the computer program causes the hardware processor to generate features at a plurality of scales from an input image using a backbone model, to encode the features using a transformer encoder that creates a per-pixel embedding map from a high-resolution scale of the plurality of scales using deformable attention layers that operate on progressively higher-resolution scales of the plurality of scales, and to decode the features using a transformer decoder to generate a segmentation mask.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of image segmentation using a transformer encoder, in accordance with an embodiment of the present invention;

FIG. 2 is an image showing an image segmentation task, in accordance with an embodiment of the present invention;

FIG. 3 is a block diagram of a transformer encoder that works on multiple token lengths, in accordance with an embodiment of the present invention;

FIG. 4 is an image of an exemplary road scene for an autonomous vehicle, in accordance with an embodiment of the present invention;

FIG. 5 is a diagram of an autonomous vehicle that can perform driving actions responsive to the outcome of an image segmentation task, in accordance with an embodiment of the present invention;

FIG. 6 is a block diagram of a computing device that can perform an image segmentation task, in accordance with an embodiment of the present invention;

FIG. 7 is a diagram of an exemplary neural network architecture that can be used to implement part of a transformer encoder, in accordance with an embodiment of the present invention; and

FIG. 8 is a diagram of an exemplary deep neural network architecture that can be used to implement part of a transformer encoder, in accordance with an embodiment of the present invention.

### DETAILED DESCRIPTION OF PREFERRED EMBODIMENTS

The performance of transformer-based segmentation models may be improved using progressive token length scaling in transformer encoders. Such encoders reduce the computational load with low performance deterioration. A model may include a backbone for multi-scale feature extraction from input images, a transformer encoder to capture long-range dependencies and contextual relationships across the features, and a transformer decoder to predict the masks and labels, along with a segmentation stage. In models using a lightweight backbone, cross-scale attention features achieve high segmentation performance, but incur a high computational cost.

An efficient transformer encoder may progressively increase the token length or input size at each encoder layer by introducing larger-scale features in the deeper layers. Small-scale features may be enhanced by explicitly modeling their interdependencies with the channels of higher-scale features using token re-calibration. The pixel embedding layer may then be simplified by using a light pixel embedding. These properties reduce the redundancy in the transformer encoder that arises from consistently maintaining a full-length token sequence across all layers of the encoder. With progressively expanding tokens, the reduction in sequence length leads to significant computational savings with minimal degradation in performance. The improved image segmentation provided by such models can be used in a variety of downstream tasks, such as object detection, thereby providing performance improvements to any task that makes use of the present image segmentation.

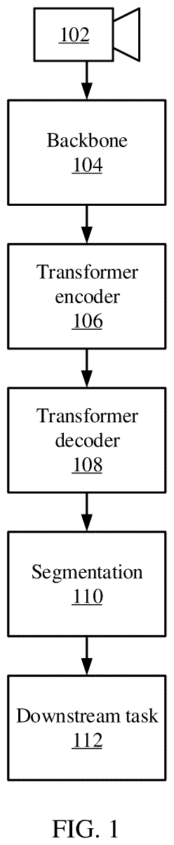

Referring now to FIG. 1, an overview of an image segmentation model is shown. A camera 102 generates a video stream that is made up of a series of images. These images are processed by backbone 104, which generates image features at multiple different scales. A transformer encoder 106 includes transformer layers and a pixel embedding layer. The transformer encoder flattens and updates the features with a gradual expansion of input tokens along with the depth of the intermediate encoder layers, providing a superior performance-efficiency tradeoff. The transformer encoder 106 may further include token recalibration, which enriches small-scale features with high-scale features to improve segmentation performance without significant computational overhead.

The transformer encoder 106 generates a vector with long-range dependencies and contextual relationships among the multi-scale backbone features. A transformer decoder 108 uses representations from the transformer encoder 106 and learnable object queries to compute mask embeddings. Segmentation 110 then uses the decoder output and per-pixel embeddings from the transformer encoder 106 to produce mask predictions using a parameter-free light-pixel embedding. The output may be used by a downstream task 112, such as object detection and open-vocabulary universal segmentation.

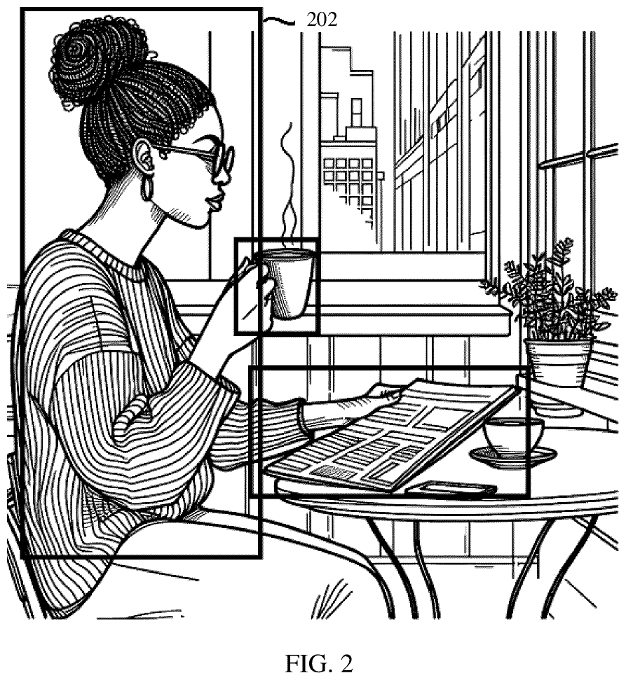

Referring now to FIG. 2, an example of object detection within an image is shown. The image illustrates a scene with a number of objects, identified by masks 202 that define a set of pixels associated with the object. In this case, the objects may include furniture, things, and people. This particular example has identified a person, a newspaper, and a cup of coffee. The output of image segmentation 110 will include the masks 202 and associated textual labels that describe the identified objects.

The backbone network 104 extracts features from the input image I∈ [symbol] ^{H×W×3}, where H and W represent the dimensions of the image in pixels with an exemplary three color channels. The backbone network can provide multi-scale feature maps {x̅₁, s̅₂, s̅₃, s̅₄}. The spatial resolutions s̅ₙ may be, for example, ¼², ⅛², 1/16², and 1/32² of the input image, respectively. The token form of these features may be represented as s₁, s₂, s₃, s₄.

The transformer encoder 106 enhances the image features {s₂, s₃, s₄} for the transformer decoder 108 and creates a per-pixel embedding map from s₁ for the final segmentation 110. Feature enhancement is performed on a token representation [symbol] ∈ [symbol] ^{K×C}, where exemplary values of K and C are K=Σ(HW/32²+HW/16²+HW/8²) and C=256. This [symbol] is composed of concatenated {s₂, s₃, s₄} obtained via flattening spatial dimensions. The transformer encoder 106 may include several stacked transformer blocks. The framework may include six deformable attention transformer layers that include a self-attention block and a feed forward block.

The transformer decoder 108, along with segmentation 110, decode binary masks from the modulated image features using a set of randomly initialized object queries, which may be used in the cross-attention mechanism of the decoder. The transformer decoder may have three stages, each with three transformer layers. Each of the decoder's transformer layers may have three transformer layers, and each of these transformer layers may include a self-attention block, a cross-attention block, and a feed-forward block. Each layer of the transformer decoder 108 may handle tokens of one scale of features for efficiency.

Large-scale features can cause a bottleneck in implementing a transformer encoder, as most are not informative but contain local details for different objects. To better handle their usage, the composition of multi-scale features from the backbone 104 can be used, as the limited quantity of small-scale features (e.g., s₃ and s₄) captures abundant semantics and the larger quantity of large-scale features (e.g., s₁ and s₂) capture local features that are important for segmenting varying scales of objects. Enrichment of the tokens may be performed with small-scale features earlier than the large-scale features.

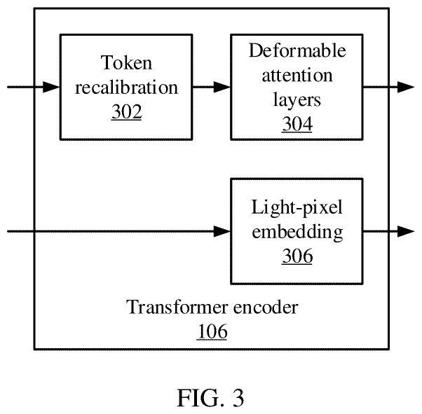

Referring now to FIG. 3, additional detail on the transformer encoder 106 is shown. The transformer encoder 106 performs token recalibration 302 on a subset of the multi-scale features from the backbone 104 to generate tokens ŝᵢ. These tokens are processed by the deformable attention layers 304 to output a set of splits at different scales, which are in turn processed by the transformer decoder 108. The highest-resolution features s₁ are combined with upsampled features from s₂ to enhance object details of s₁ with those of s₂. The combined features are processed by light-pixel embedding 306 to output a per-pixel embedding map ϵ_{emb}, which is combined with the output of the transformer decoder 108.

Token recalibration 302 avoids map errors caused by imperfect token representations by calibrating the s₃ and s₄ features using s₂. Small-scale features sᵢ∈{s₃, s₄} are enhanced using large-scale features s₂ without increasing the computational burden in the transformer layers. Contrastive attention is used to enrich the tokens of sᵢ by projecting s₂ onto sᵢ using an attention map. The attention map is obtained using a channel reduction layer ο followed by a sigmoid function. The final tokens ŝᵢ are obtained as:

$${\hat{s}}_{i} = {s}_{i} ⊗ sigmoid ( ϵϕ ( {s}_{2} ) )$$

where ⊗ is element-wise multiplication. The channel reduction ϕ may be implemented as a linear layer and ϵ is a temperature parameter (e.g., about 0.1).

The deformable attention layers 304 are implemented as a sequence of attention layers, with three splits of the feature queries [symbol] , which relate to the self-attention mechanism of the encoder. Deformable attention has linear complexity with the number of feature queries. [symbol] may be split into the following three scales:

$${1}_{} = 𝒞 ( {s}_{4} ) ∈ {ℝ}^{{K}_{1} \times C}$$

$${2}_{} = 𝒞 ( {s}^{′} , {s}_{3} ) ∈ {ℝ}^{{K}_{2} \times C}$$

$${3}_{} = 𝒞 ( {s}^{″} , {s}_{2} ) ∈ {ℝ}^{{K}_{3} \times C}$$

where [symbol] (·) denotes the concatenation operation along the token dimension size, K₁=HW/32², K₂=Σ(HW/32²+HW/16²), K₃=Σ(HW/32²+HW/16²+HW/8²), and C is a number of channels for the features. The feature s′ is the output of the first attention layer and the feature s″ is the output of the second attention layer. The third attention layer outputs feature s′″.

These splits are fed to the three stages of the deformable attention transformer layers 304 sequentially. The output s′″ is fed to the transformer decoder 108. Each stage is repeated p₁, p₂, and p₃ times, respectively, before propagating the tokens to the next stage. This updates s₄ (p₁+p₂+p₃) times, s₃ (p₂+p₃) times, and s₂ p₁ times, gradually expanding the token length of inputs to intermediate layers.

Multi-scale features from the backbone 104, including tokens {s₂, s₃, s₄}, are fed to the transformer encoder 106 to compute s′″ produce per-segment embeddings in the transformer decoder 108. The largest-scale feature s₁, on the other hand, serves the purpose of creating the per-pixel embedding map ϵ_{emb}. The light-pixel embedding 306 uses a two-dimensional max pooling layer followed by normalization and non-linearity to compute ϵ_{emb}, for example using a pooling kernel of size 3. The map may be normalized and passed to a rectified linear unit (ReLU) layer before being combined with an output of the transformer decoder 108 to generate a segmentation mask via element-wise multiplication. The light-pixel embedding 306 decreases the computational overhead of creating the embedding map without impairing segmentation performance.

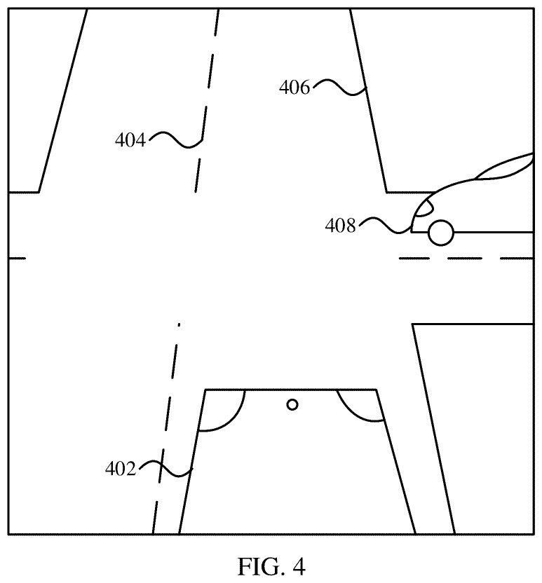

Referring now to FIG. 4, an exemplary road scene is shown for use in a downstream task 112. The scene may be captured by a camera that is mounted on a vehicle 402, and may show the surroundings of the vehicle 402 from a particular perspective. It should be understood that multiple such images may be used to show various perspectives, to ensure awareness of the vehicle's entire surroundings. In some cases, a panoramic or 360° camera may be used. In some cases the scene information may include depth information, such as is generated by a light detection and ranging (LiDAR) sensor.

The scene may show a variety of objects. For example, the scene may include environmental features, such as the road boundary 406 and lane markings 404, as well as moving objects, such as other vehicles 408. Other objects, such as pedestrians, animals, road obstructions, road hazards, street lights, and barriers may also be included.

Object detection may be used to identify objects within the road scene, and semantic labeling of those objects may further be used to predict their behavior and their impact on the vehicle's path. Thus segmentation 110 may be used to split the image of the road scene into areas that are associated with different objects in the scene. In some cases the downstream task 112 may further include automatically causing the vehicle 402 to take a driving action, such as an acceleration action, a braking action, or a steering action, to help guide the vehicle 402 toward its destination in a safe manner that accounts for the detected objects in the scene.

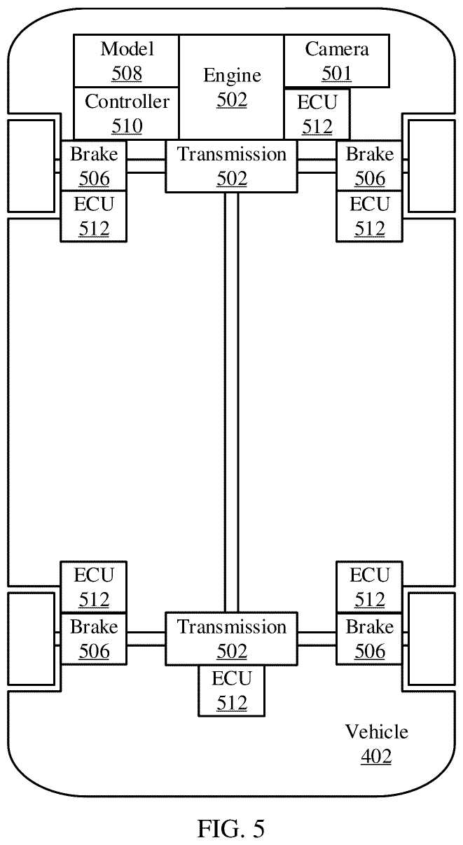

Referring now to FIG. 5, additional detail on a vehicle 402 is shown. A number of different sub-systems of the vehicle 402 are shown, including an engine 502, a transmission 504, and brakes 506. It should be understood that these sub-systems are provided for the sake of illustration, and should not be interpreted as limiting. Additional sub-systems may include user-facing systems, such as climate control, user interface, steering control, and braking control. Additional sub-systems may include systems that the user does not directly interact with, such as tire pressure monitoring, location sensing, collision detection and avoidance, and self-driving.

Each sub-system is controlled by one or more equipment control units (ECUs) 512, which perform measurements of the state of the respective sub-system. For example, ECUs 512 relating to the brakes 506 may control an amount of pressure that is applied by the brakes 506. An ECU 512 associated with the wheels may further control the direction of the wheels. The information that is gathered by the ECUs 512 is supplied to the controller 510. A camera 501 or other sensor (e.g., LiDAR or RADAR) can be used to collect information about the surrounding road scene, and such information may also be supplied to the controller 510.

Communications between ECUs 512 and the sub-systems of the vehicle 402 may be conveyed by any appropriate wired or wireless communications medium and protocol. For example, a car area network (CAN) may be used for communication. The time series information may be communicated from the ECUs 512 to the controller 510, and instructions from the controller 510 may be communicated to the respective sub-systems of the vehicle 402.

Information from the camera 501 and other sensors is provided to the model 508, which may select an appropriate action to take. The controller 510 uses the output of the model 508, based on information collected from cameras 501, to perform a driving action responsive to the present state of the scene. The use of the present transformer encoder 106 makes it possible to perform segmentation tasks and object detection with a low computational burden for the controller 510.

The controller 510 may communicate internally to the sub-systems of the vehicle 402 and the ECUs 512. Based on detected road fault information, the controller 510 may communicate instructions to the ECUs 512 to avoid a hazardous road condition. For example, the controller 510 may automatically trigger the brakes 506 to slow down the vehicle 402 and may furthermore provide steering information to the wheels to cause the vehicle 402 to move around a hazard.

Referring now to FIG. 4, an exemplary computing device 400 is shown, in accordance with an embodiment of the present invention. The computing device 400 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 400 may be embodied as one or more compute sleds, memory sleds, or other racks, sleds, computing chassis, or other components of a physically disaggregated computing device.

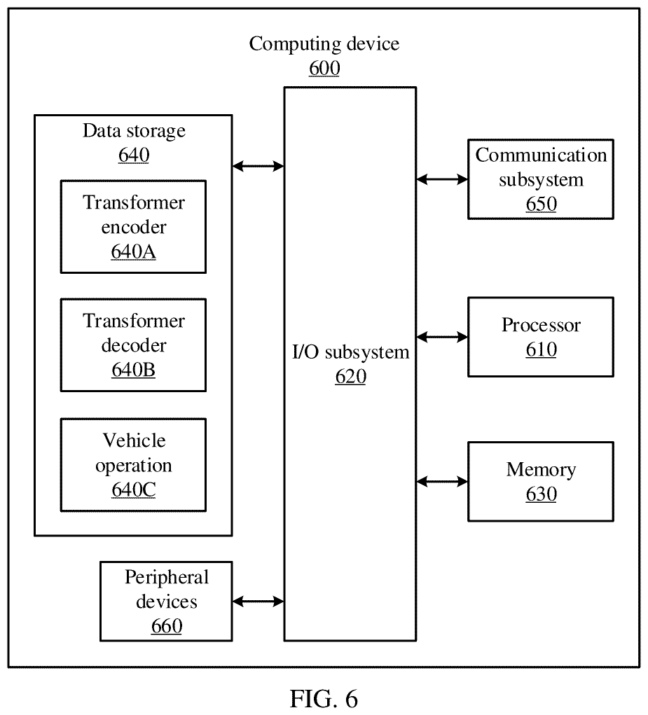

As shown in FIG. 6, the computing device 600 illustratively includes the processor 610, an input/output subsystem 620, a memory 630, a data storage device 640, and a communication subsystem 650, and/or other components and devices commonly found in a server or similar computing device. The computing device 600 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 630, or portions thereof, may be incorporated in the processor 610 in some embodiments.

The processor 610 may be embodied as any type of processor capable of performing the functions described herein. The processor 610 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 630 may be embodied as any type of volatile or non-volatile memory or data storage capable of performing the functions described herein. In operation, the memory 630 may store various data and software used during operation of the computing device 600, such as operating systems, applications, programs, libraries, and drivers. The memory 630 is communicatively coupled to the processor 610 via the I/O subsystem 620, which may be embodied as circuitry and/or components to facilitate input/output operations with the processor 610, the memory 630, and other components of the computing device 600. For example, the I/O subsystem 620 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 620 may form a portion of a system-on-a-chip (SOC) and be incorporated, along with the processor 610, the memory 630, and other components of the computing device 600, on a single integrated circuit chip.

The data storage device 640 may be embodied as any type of device or devices configured for short-term or long-term storage of data such as, for example, memory devices and circuits, memory cards, hard disk drives, solid state drives, or other data storage devices. The data storage device 640 can store program code 640A for a transformer encoder, 640B for a transformer decoder, and/or 640C for performing vehicle operation actions using the trained planner model. Any or all of these program code blocks may be included in a given computing system. The communication subsystem 650 of the computing device 600 may be embodied as any network interface controller or other communication circuit, device, or collection thereof, capable of enabling communications between the computing device 600 and other remote devices over a network. The communication subsystem 650 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 600 may also include one or more peripheral devices 660. The peripheral devices 660 may include any number of additional input/output devices, interface devices, and/or other peripheral devices. For example, in some embodiments, the peripheral devices 660 may include a display, touch screen, graphics circuitry, keyboard, mouse, speaker system, microphone, network interface, and/or other input/output devices, interface devices, and/or peripheral devices.

Of course, the computing device 600 may also include other elements (not shown), as readily contemplated by one of skill in the art, as well as omit certain elements. For example, various other sensors, input devices, and/or output devices can be included in computing device 600, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 600 are readily contemplated by one of ordinary skill in the art given the teachings of the present invention provided herein.

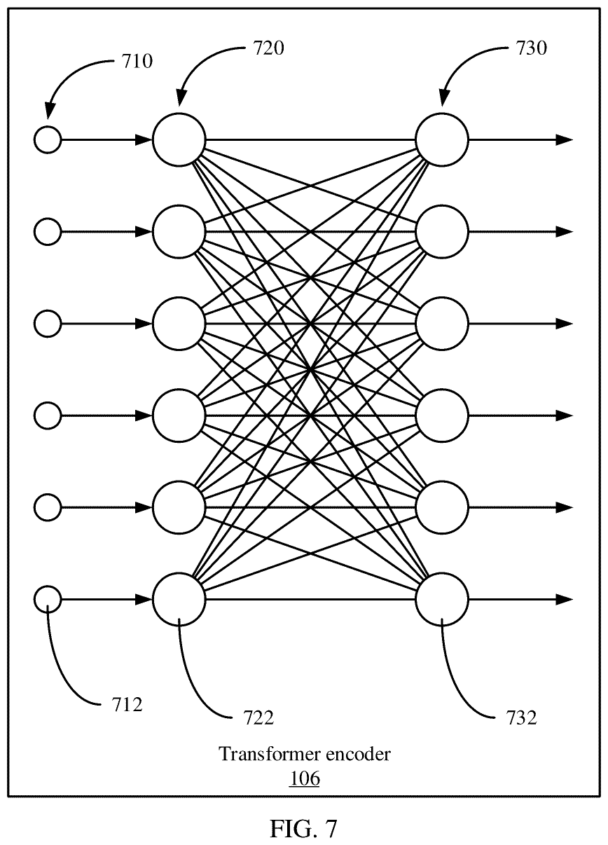

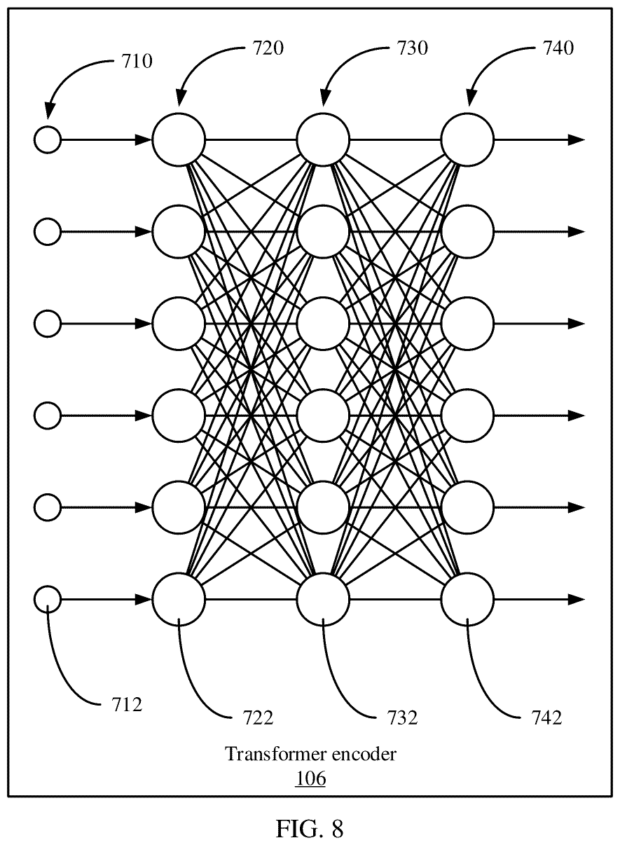

Referring now to FIGS. 7 and 8, exemplary neural network architectures are shown, which may be used to implement parts of the present models, such as the transformer encoder 106. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 720 of source nodes 722, and a single computation layer 730 having one or more computation nodes 732 that also act as output nodes, where there is a single computation node 732 for each possible category into which the input example could be classified. An input layer 720 can have a number of source nodes 722 equal to the number of data values 712 in the input data 710. The data values 712 in the input data 710 can be represented as a column vector. Each computation node 732 in the computation layer 730 generates a linear combination of weighted values from the input data 710 fed into input nodes 720, and applies a non-linear activation function that is differentiable to the sum. The exemplary simple neural network can perform classification on linearly separable examples (e.g., patterns).

A deep neural network, such as a multilayer perceptron, can have an input layer 720 of source nodes 722, one or more computation layer(s) 730 having one or more computation nodes 732, and an output layer 740, where there is a single output node 742 for each possible category into which the input example could be classified. An input layer 720 can have a number of source nodes 722 equal to the number of data values 712 in the input data 710. The computation nodes 732 in the computation layer(s) 730 can also be referred to as hidden layers, because they are between the source nodes 722 and output node(s) 742 and are not directly observed. Each node 732, 742 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 732 in the one or more computation (hidden) layer(s) 730 perform a nonlinear transformation on the input data 712 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”', for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer implemented method for image segmentation, comprising:
generating features at a plurality of scales from an input image using a backbone model;
encoding the features using a transformer encoder that creates a per-pixel embedding map from a high-resolution scale of the plurality of scales using deformable attention layers that operate on progressively higher-resolution scales of the plurality of scales; and
decoding the features using a transformer decoder to generate a segmentation mask.

2. The method of claim 1, further comprising performing token recalibration on features at lower-resolution scales based on an attention map from a higher-resolution scale to generate recalibrated tokens.

3. The method of claim 2, wherein performing token recalibration includes generating the attention map by channel reduction of flattened features at the higher-resolution scale.

4. The method of claim 2, wherein token recalibration is performed by an element-wise multiplication between the features at the lower-resolution scales with the attention map.

5. The method of claim 2, wherein encoding the features includes applying the recalibrated tokens to the respective deformable attention layers.

6. The method of claim 1, further comprising performing light-pixel embedding on features of the high-resolution scale to generate a per-pixel embedding map, and generating the segmentation mask by combining the per-pixel embedding map with an output of the transformer decoder.

7. The method of claim 6, wherein light-pixel embedding includes a max pooling layer with a pooling kernel size of 3.

8. The method of claim 6, wherein combining the per-pixel embedding map with the output of the transformer decoder includes an element-wise multiplication.

9. The method of claim 1, further comprising performing object detection in the input image using the segmentation mask.

10. The method of claim 9, further comprising automatically performing a driving action in an autonomous vehicle responsive to the object detection.

11. A system for image segmentation, comprising:
a hardware processor; and
a memory that stores a computer program which, when executed by the hardware processor, causes the hardware processor to:
generate features at a plurality of scales from an input image using a backbone model;
encode the features using a transformer encoder that creates a per-pixel embedding map from a high-resolution scale of the plurality of scales using deformable attention layers that operate on progressively higher-resolution scales of the plurality of scales; and
decode the features using a transformer decoder to generate a segmentation mask.

12. The system of claim 11, wherein the computer program further causes the hardware processor to perform token recalibration on features at lower-resolution scales based on an attention map from a higher-resolution scale to generate recalibrated tokens.

13. The system of claim 12, token recalibration includes generation of the attention map by channel reduction of flattened features at the higher-resolution scale.

14. The system of claim 12, wherein token recalibration includes an element-wise multiplication between the features at the lower-resolution scales with the attention map.

15. The system of claim 12, wherein the encoding of the features includes application of the recalibrated tokens to the respective deformable attention layers.

16. The system of claim 11, wherein the computer program further causes the hardware processor to perform light-pixel embedding on features of the high-resolution scale to generate a per-pixel embedding map, and to generate the segmentation mask by combining the per-pixel embedding map with an output of the transformer decoder.

17. The system of claim 16, wherein the light-pixel embedding includes a max pooling layer with a pooling kernel size of 3.

18. The system of claim 16, wherein the combination of the per-pixel embedding map with the output of the transformer decoder includes an element-wise multiplication.

19. The system of claim 11, wherein the computer program further causes the hardware processor to perform object detection in the input image using the segmentation mask.

20. The system of claim 19, wherein the computer program further causes the hardware processor to automatically perform a driving action in an autonomous vehicle responsive to the object detection.
